(19) United States
(12) Patent Application Publication
(10) Pub. No.: US 2007/0053074 A1
(43) Pub. Date: Mar. 8, 2007

(54) Projection display with light recycling

(75) Inventors: Marcellinus Petrus Carolus Michael Krijn, Eindhoven (NL); Siebe Tjerk Zwart, Valkenswaard (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., Eindhoven (NL)

(21) Appl. No.: 10/586,182

(22) PCT Filed: Jan. 25, 2005
(86) PCT No.: PCT/IB05/50298

§ 371 Date: Jul. 17, 2006

(30) Foreign Application Priority Data
Jan. 30, 2004 (US) 60540708

(51) Int. Cl. G02B 17/00

(52) U.S. Cl. 359/726

(57) ABSTRACT

A light-valve system is adapted to recycle light includes a light-valve, which is optically coupled to a projection lens. The illustrative systems also includes a light recycling device, which reflects at least a portion of the light that is reflected by the light valve back along a light path of the system and to an imaging surface increasing the brightness of an image.

Light-valve projection systems projection displays may be used in projection televisions, computer monitors, point of sale displays, and electronic cinema to mention only a few applications.

One type of light-valve projection system incorporates a digital micro-mirror device (DMD) as the light-valve, rather than a liquid crystal (LC) light-valve. A digital micro-mirror device (DMD) is a known device, which is based on an array of micro-mirrors. Each picture element (pixel) consists of a single mirror that can be rotated in a about an axis. In operation, each mirror is rotated to a first position or a second position. In the first position, light incident on the mirror is reflected from the mirror to a projection lens, and to the imaging surface (viewing screen). In the second position, light incident is reflected by the mirror and is not coupled to the projection lens. Thereby, in the first position, a bright-state pixel is formed at the imaging surface, and in the second position, a dark-state pixel is formed at the imaging surface. Grey scales may be made by sub-field addressing. In single-panel DMD projectors, color is obtained by color sequential techniques. From these basic principles, images may be formed at the imaging surface.

As can be appreciated, light valve projection systems such as those referenced previously can be rather inefficient at transmitting light to the imaging surface. For example, each dark-state pixel in a particular frame or image results from the prevention of light from reaching the image surface. This dark-state light is lost to the return light path in known systems. As can be readily appreciated this results inefficient light loss at the imaging surface. The inefficiencies of such known systems can have deleterious effects on the image displayed. For example, losses in light energy can result in reduced brightness.

What is needed therefore, is a method and apparatus that addresses at least the shortcomings of known systems described above.

In accordance with an example embodiment, a color-sequential projection system adapted to recycle light includes a non-liquid crystal light-valve, which is optically coupled to a projection lens. The illustrative Systems also includes a light recycling device, which reflects at least a portion of the light that is reflected by the light valve back along a light path of the system and to an imaging surface increasing the brightness of an image.

In accordance with another example embodiment, a method of recycling light in a non-liquid crystal light-valve system includes selectively reflecting a portion of light received from a light-valve back along a light path of the system. The method also includes transmitting at least a portion of the reflected light to an imaging surface increasing the brightness of an image.

The invention is best understood from the following detailed description when read with the accompanying drawing figures. It is emphasized that the various features are not necessarily drawn to scale. In fact, the dimensions may be arbitrarily increased or decreased for clarity of discussion.

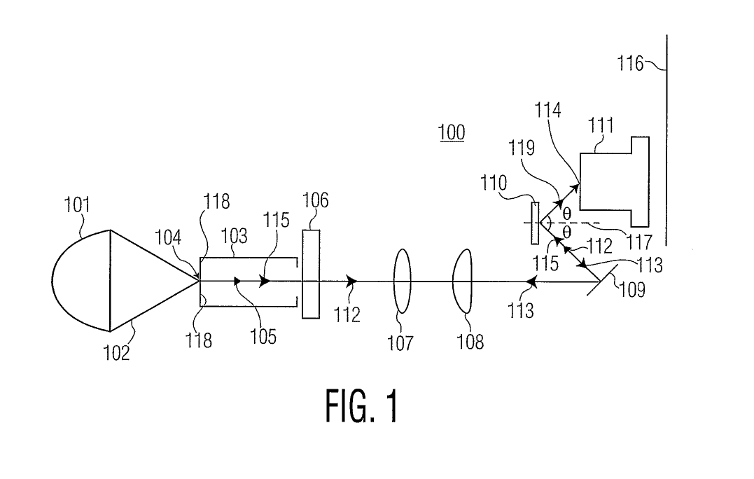

FIG. 1 is a schematic diagram of a projection system in accordance with an example embodiment.

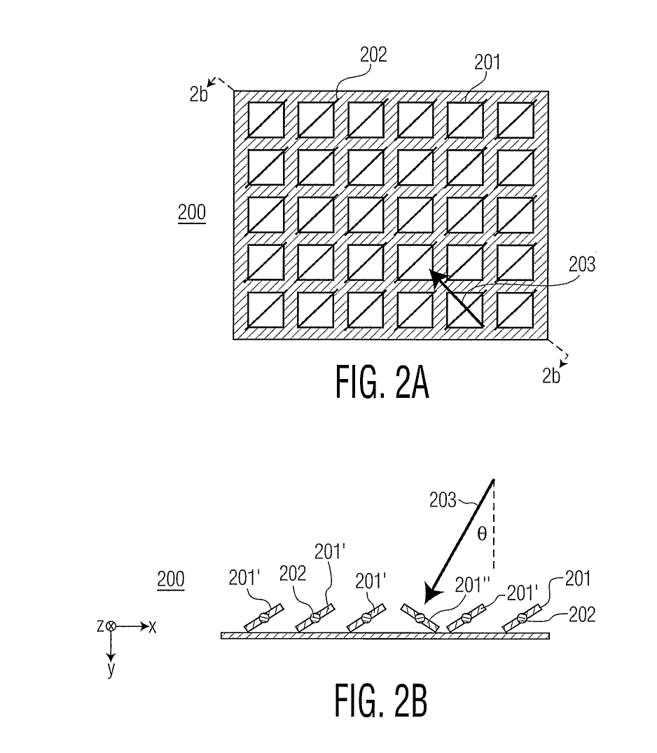

FIGS. 2a and 2b are top and cross-sectional views, respectively, of a DMD light valve in accordance with an example embodiment.

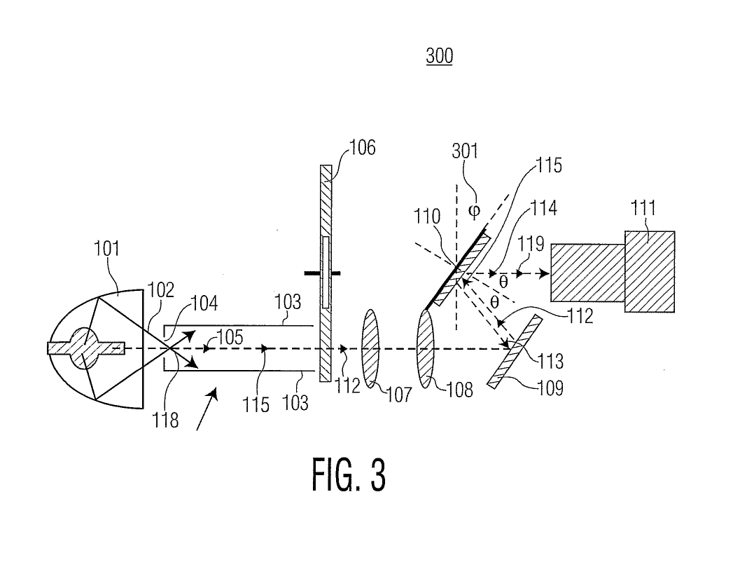

FIG. 3 is a schematic diagram of a light-valve projection system in accordance with an example embodiment.

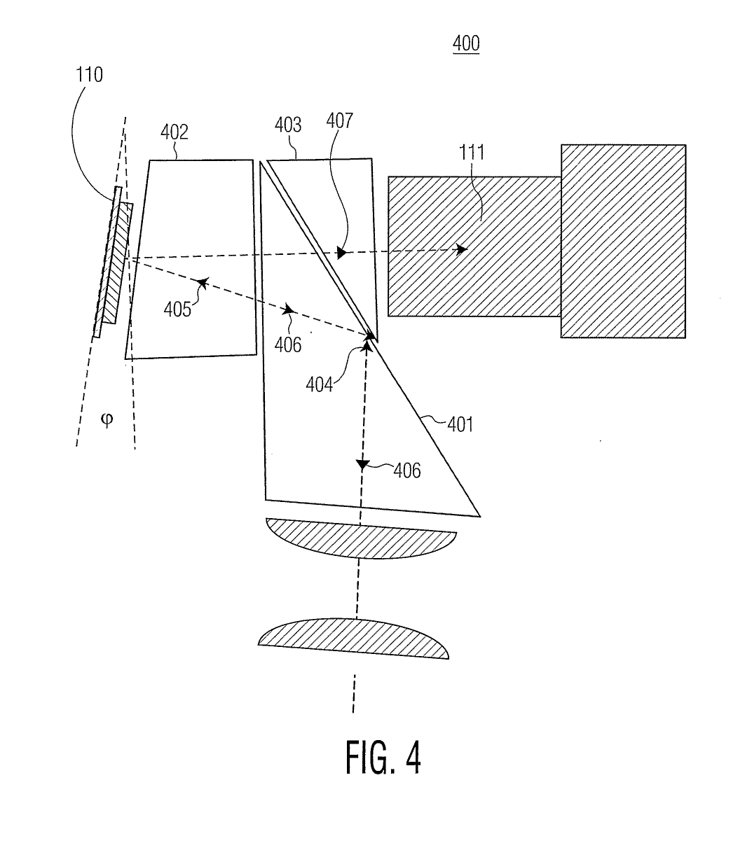

FIG. 4 is a perspective view of an optical lens system for coupling light to a projection lens in accordance with an example embodiment.

In the following detailed description, for purposes of explanation and not limitation, example embodiments disclosing specific details are set forth in order to provide a thorough understanding of the present invention. However, it will be apparent to one having ordinary skill in the art having had the benefit of the present disclosure, that the present invention may be practiced in other embodiments that depart from the specific details disclosed herein. Moreover, descriptions of well-known devices, methods and materials may be omitted so as to not obscure the description of the present invention. Wherever possible, like numerals refer to like features throughout.

Briefly, in accordance with example embodiments, non-liquid crystal (non-LC) light-valve color sequential projection systems include a method and apparatus for recycling light to improve the overall brightness of the image at the viewing surface (projection screen). Illustratively, the projection systems of example embodiments include an optical structure, which recycles light that is not initially transmitted to the projection optics (e.g., dark state light). Other light that is reflected back into the system may be similarly recycled by the optical structure. This recycling allows light that is precluded from reaching the screen initially to reach the screen, and thus increase the overall brightness levels of the image.

FIG. 1 shows a color sequential projection system 100 according to an example embodiment. The system 100 includes a reflective element 101, which is illustratively an ellipsoid reflector that is known to one of ordinary skill in the art. A light source (not shown), such as a high-intensity gas discharge lamps such as ultra high pressure (UHP) gas discharge lamps, which are well known in the art. Light 102 is reflected from the reflector 101 and is incident on an aperture 104 of a waveguide 103. The waveguide 103 usefully is a light homogenizer and integrator. To wit, the output of the waveguide 103 is substantially homogeneous. The waveguide 103 substantially exhibits total internal reflection (TIR). Illustratively, the waveguide 103 may be a cylindrical device or polygonal device with a rectangular or square cross-section. An example of such a waveguide is found in U.S. Patent Publication No. 2003/0086066 A1 to Kato, the disclosure of which is specifically incorporated herein by reference.

The aperture 104 serves as the entrance to the waveguide for the light 102, and as an exit opening for light returning in a direction of propagation in the return light (i.e., light propagating toward the reflective element 101). However, the aperture 104 usefully prevents light propagating in the return light path that is incident thereon. It is noted that the details of this returning light will become clearer as the present description continues.

The guided light 105 is transmitted along the waveguide and is emitted therefrom onto a color wheel 106, which provides sequential color illumination to the system 100. The color wheel 106 usefully transmits red, blue and green light sequentially. An example of a color wheel employable in the system 100 may be found in International Patent Application (WIPO) WO 02/096122 A1, to De Vaan, et al. The disclosure of this application is specifically incorporated herein by reference. It is noted that other color sequencing filters may be used instead of the color wheel. For example, color shutters or color filters of the type described in U.S. Pat. No. 6,273,571 to Sharp, et al. and assigned to ColorLink, Incorporated, may be used. The disclosure of this patent is specifically incorporated herein by reference. Additionally, other color shutters or color filters manufactured by ColorLink, Incorporated may be used in this manner.

Light 112 then emerges from the color wheel 106 and is incident on optical elements 107, 108, which usefully focus the light for efficient transmission to an imaging surface (screen) 116. After traversing the lens elements 107, 108, the light 112 is reflected from a reflector 109, which is illustratively a mirror. As will become more clear as the present description continues, the mirror is oriented relative to a light valve 110 so that the light 112 is incident in a plane that is orthogonal to the rotational axes of the micro-mirrors of a DMD. Of course, this selective placement and orientation of the mirror 109 impacts the placement and orientation of the other elements (lens elements 107, 108; color wheel 106; waveguide; and reflective element 101) of the system 100. As this impact is readily understood by the artisan of ordinary skill, these details are omitted so as to not obscure the description of the example embodiments.

The light 112 reflected from the mirror is incident on the surface of the light-valve 110, which is illustratively a DMD. It is noted that other types of light-valves, which are not based on LC technology, may be used. As shown in FIG. 1, and as described more fully herein, the light 112 is incident at an angle, θ, relative to the normal 117 to the surface of the DMD 110. Stated differently, the light 112 is in a plane of incidence that is at an angle, θ, relative to the plane normal to the surface of the DMD 110. Moreover, the light 112 is incident orthogonally to the axes of the pixels of the DMD 111.

As described more fully herein, the pixels of the DMD are selectively oriented so that light from the bright-state pixels of the DMD is reflected as light 114. This bright-state light 114 is then incident on the projection lens 111 for transmission to the imaging surface 116.

Contrastingly, in accordance with an example embodiment, the dark-state pixels of the DMD are oriented so that the light reflected therefrom is returned in the light path of the system and towards the waveguide 103. This dark-state light 113 is usefully recycled and projected onto the imaging surface 116, thereby improving the overall brightness of the image.

Before addressing the recycling of the light 113 of an example embodiment, the placement of the projection lens 111 relative to the DMD 110 is usefully described. In order to avoid tilting the imaging surface that may be required if the DMD is tilted to accommodate reflecting dark-state light along the return light path, the projection lens 111 is offset relative to the DMD. The offsetting of the projection lens 111 is often effected if the projector is positioned on a surface, resulting in part of the image's being intercepted by the surface or projected at a lower level than the level of the surface. Hence, the vertical position of the projection lens is higher than that of the DMD chip. In keeping with the example embodiments described in connection with FIG. 1, the angle corresponding to the offset is on the order of approximately 10° to approximately 15°. Finally, it is noted that the DMD 110 and the imaging surface 116 are usefully in parallel planes.

The light 113 reflected from the dark-state pixels of the DMD returns across the light path in keeping with the principle of reciprocity of optics. To wit, the light 113 is reflected from the mirror 109 and traverses the lens elements 108 and 107. The light 113 then traverses the color wheel and is guided by the waveguide 103, where it is reflected from a rear surface 118, which may include a reflective coating for improving the reflection. As noted above, the aperture 104 has a rather small area, and thus a relative small portion of the reflected light is transmitted through the aperture. It is noted that this light may also be reflected from the reflective element 101 and thus recycled in the same manner as light 113 that is reflected from the rear surface 118.

The light 115 reflected from the surface 118 then traverses the system 100, traversing the color wheel, the lens elements 107, 108; and being reflected by the mirror 109 and onto the DMD 110. In accordance with the example embodiment of FIG. 1, a significant portion of the light 115 (shown as light 119) is incident on the projection lens 111. To this end, if all of the micro-mirrors of the DMD 110 are in a ‘bright-state’ orientation (described more fully in connection with the example embodiment of FIGS. 2a and 2b), the light 115 is substantially reflected and is incident as light 119 on the projection lens. As can be appreciated, the recycled light is beneficial to improving brightness at the imaging surface.

FIG. 2a shows a DMD 200 (or portion thereof) in accordance with an example embodiment. FIG. 2b is a cross-sectional view of the DMD along the line 2b-2b. The DMD 200 may be used as the light-valve/DMD 110 of the example embodiment of FIG. 1. The DMD 200 includes a plurality of reflective elements 201, which are each rotated about respective axes 202. These reflective elements 201 may be mirrors or other reflective elements. The actuation of rotation and the selection of the rotation of each particular element 201 is effected by control elements (not shown). As DMD's are known to one skilled in the art, certain known details are omitted to over obscuring the description of the example embodiments.

Light 203 is incident on each of the elements 201. This light 203 may be light 112 or 115 described above. Usefully, the light 203 is incident in a plane that is orthogonal to the plane of the axes 202. To wit, regardless of the angle of incidence, θ, the light 203 is always orthogonal to the axes 202 (i.e., the light 203 is in the x-y plane, where the axes 202 are along the z-axis of the coordinate system shown in FIG. 2b). This fosters the reflection of light from the DMD in the return light path for recycling as well as the reflection of light to the projection lens of the system. For purposes of illustration, it is noted that the axes 202 of the reflective elements 201 of the DMD would be orthogonal to the plane of incidence of light 112, thereby fostering its reflection as light 113 for recycling by the waveguide 103.

In operation, the reflective elements 201 are rotated about their respective axes 202, with elements 201′ being oriented so that the incident light 203 is reflected toward the projection lens, and element 201″ being oriented so that the incident light 203 is reflected by 180° or directly back from its direction of incidents. In keeping with the above description, the elements 201′ form the bright-state pixels and the elements 201″ form the dark-state pixels. Of course, images are formed continuously by altering the orientation of the elements 201 from an on-state to an off-state as required. Thus, the orientation of the elements 201 is bipolar (for dark-state and bright-state) and each may be rapidly altered to form an image of bright and dark pixels. The angle of orientation for the elements is on the order of approximately ±10°, or a tilt of approximately 20° between the bright-state elements (201′) and the dark-state elements (202″). Finally, it is noted that if all of the pixels are in the bright-state orientation, the light 203 is completely transmitted to the projection optics of the system. This may be advantageous in recycling light such as light 115/119.

In accordance with example embodiments, the improvement in brightness of the overall image is significant due to the recycling of reflected light. To wit, if a represents the average display load (relative to 100%), and b represents the light recycling efficiency of the light-valve projection system, the upon recycling the light that is redirected back into the optical path by the DMD (e.g., light 112 of the example embodiment above), the brightness will be increased by a factor G, where G is given by:
G=[1−(b(1−a))]⁻¹ (1)

In the example embodiments, the waveguide (e.g., waveguide 103) may have a recycling efficiency of approximately 60% (b=0.6), and for video, the display load is approximately 20% (a=0.2). Thus, in accordance with example embodiments, the gain factor, G, may be on the order of approximately 1.9, or nearly a doubling of the brightness.

The light which does not undergo a polarization transformation upon emerging from the reflective light-valve is again reflected at the interface 113 as reflected light 118. Because this light is not ultimately incident on the image surface, it effects the ‘dark’ pixels of the image.

FIG. 3 shows a color sequential light-valve projection system 300 in accordance with an example embodiment. The system 300 is substantially the same as the system of the example embodiment of FIG. 1, and as such, duplicative descriptions are foregone in the interest of brevity and clarity. A significant difference between the two embodiments lies in the orientations of the DMD 110 and the projection lens 111. As to the former, the DMD is oriented at an angle (φ) 301, which is determined by the deflection angle of the elements 201 and the orientation of the axes of the DMD. As to the latter, the projection lens 111 is not offset relative to the DMD.

In keeping with the example embodiments of FIG. 3, the orientation of the DMD 110 relative to the other elements of the system fosters the reflection of light 113 from dark-state pixels of the DMD 110 to the waveguide 103 via the light path. Again, the waveguide 103 reflects and guides the light back to the mirror 109 and to the DMD 110, where it may be reflected as light 119. Thereby beneficial light recycling may be effected.

FIG. 4 shows an embodiment of an optical system 400 for use in the projection systems of the example embodiments described. While the system 400 shows the DMD 110 tilted as in FIG. 3, it is noted that proper selection of elements would allow the system 400 to be used in the embodiments of FIG. 1. The optical system 400 includes prism elements 401, 402 and 403. The prisms 401-403 and the principles of total internal reflection are used to separate the incoming and outgoing light beams. To this end, incoming light 404, which may be from the projection system 300, is reflected by prism 401. This light is then incident on the DMD 110, and is reflected as either dark-state light 406, or as bright-state light 407, depending on the orientation of the elements of the DMD 110. The dark-state-light is then recycled as light 405 by the system 300.

The example embodiments having been described in detail in connection through a discussion of exemplary embodiments, it is clear that modifications of the invention will be apparent to one having ordinary skill in the art having had the benefit of the present disclosure. Such modifications and variations are included in the scope of the appended claims.

1. A color sequential projection system adapted to recycle light, comprising:
a non-liquid crystal (LC) light-valve, which is optically coupled to a projection lens;
a light recycling device, which reflects at least a portion of the light that is reflected by the light-valve back along a light path of the system, and to an imaging surface increasing the brightness of an image.

2. A projection system as recited in claim 1, wherein the light-valve is a digital micro-mirror device (DMD).

3. A projection system as recited in claim 2, wherein the DMD includes a plurality of reflective elements each having a respective axis about which the element rotates, and the DMD is oriented so light incident from the system is in a plane that is perpendicular to a plane of the axes.

4. A projection system as recited in claim 1, wherein the light recycling device includes a waveguide.

5. A projection system as recited in claim 4, wherein the waveguide has a reflective surface and an aperture on one end thereof.

6. A projection system as recited in claim 1, further comprising a color wheel disposed between the waveguide and a projection lens.

7. A projection system as recited in claim 1, further comprising at least one prism, which reflects light from the DMD back to the system.

8. A projection system as recited in claim 2, wherein a projection lens is offset relative to the DMD.

9. A projection system as recited in claim 2, wherein the DMD is tilted relative to a projection lens.

10. A method of recycling light in a color sequential projection system, the method comprising:
selectively reflecting a portion of light received from a non-liquid crystal light-valve back along a light path of the system; and transmitting at least a portion of the reflected light to an imaging surface increasing the brightness of an image.

11. A method as recited in claim 10, wherein the light-valve is a DMD.

12. A method as recited in claim 11, wherein the DMD includes a plurality of reflective elements each having an axis about which the element rotates, and the DMD is oriented so light incident from the system is in a plane that is perpendicular to a plane of the axes.

13. A method as recited in claim 10, wherein the light recycling device includes a waveguide.

14. A method as recited in claim 13, wherein the waveguide has a reflective surface and an aperture on one end thereof.

15. A method as recited in claim 13, further comprising a color wheel disposed between the waveguide and a projection lens.

16. A method as recited in claim 11, further comprising at least one prism, which reflects light from the DMD back to the system.

17. A method as recited in claim 11, wherein a projection lens is offset relative to the DMD.

18. A projection system as recited in claim 11, wherein the DMD is tilted relative to a projection lens.
